(19) United States
(12) Patent Application Publication
(10) Pub. No.: US 2024/0094159 A1
(43) Pub. Date: Mar. 21, 2024

(54) ELECTROCHEMICAL GAS SENSOR AND FABRICATION METHOD THEREFOR

(71) Applicant: SUNVOU MEDICAL ELECTRONICS CO., LTD., Wuxi (CN)

(72) Inventors: Lichun Zheng, Wuxi (CN); Tianli Liu, Wuxi (CN); Jie Han, Wuxi (CN)

(73) Assignee: SUNVOU MEDICAL ELECTRONICS CO., LTD., Wuxi (CN)

(21) Appl. No.: 18/274,949

(22) PCT Filed: Sep. 29, 2022
(86) PCT No.: PCT/CN2022/122467

§ 371 Date: Jul. 28, 2023

(30) Foreign Application Priority Data
Dec. 31, 2021 (CN) 202111656989.8

(51) Int. Cl. G01N 27/404

(52) U.S. Cl. CPC G01N 27/4045

(57) ABSTRACT

Provided are an electrochemical gas sensor and a fabrication method therefor. A sensing electrode, a reference electrode and an auxiliary electrode in a planar arrangement are arranged on an upper layer in a sensor housing, and an electrolyte and a membrane material are arranged on a lower layer in the sensor housing. An upper part of the sensor housing is provided with a vent, and a lower part of the sensor housing is provided with a connector for connecting three electrodes and connected to an external circuit. Compared with the traditional cylindrical stacked electrochemical gas sensor, the fabrication method for a plate-body thin-film type sensor is simple, is less affected by the change of ambient pressure, temperature and humidity, and is beneficial to the flattening and miniaturization of electronic instruments and apparatus for gas analysis.

### CROSS-REFERENCE TO RELATED APPLICATION

This patent application is a national stage application of International Patent Application No. PCT/CN2022/122467, filed on Sep. 29, 2022, which claims the priority of Chinese Patent Application No. 202111656989.8 filed with the China National Intellectual Property Administration on Dec. 31, 2021, and entitled “Electrochemical gas sensor and fabrication method therefor”, the disclosure of which is incorporated by reference herein in the present application.

### TECHNICAL FIELD

The present disclosure relates to the field of electrochemical gas sensors, in particular to an electrochemical gas sensor and a fabrication method therefor.

### BACKGROUND

The traditional electrochemical gas sensor originated in 1960s, which adopted a cylindrical vacuum tube and transistor design similar to that at that time. Two, three or four electrodes, an electrolyte, a liquid absorbing membrane and a permeable membrane in the sensor are stacked layer by layer or are in a cylindrical stacked structure (referring to patents CN211148505U, CN107991366A, US20210172901A1, EP1305837B1). This sensor design, which has been used until now, has at least the following defects:

First, there are numerous fabrication processes for the stacked structure, most of which require manual assembly, leading to time and energy waste.

Secondly, a stress structure of the stacked structure is complicated. When the ambient temperature, humidity or pressure changes, it is easy to cause problems such as electrode breakage, poor contact, electrolyte swelling and leakage, etc.

Thirdly, the high stacked cylinder design has poor matching degree or compatibility with modern thin-film electronic devices or products, which is not conducive to the flattening of gas detection electronic instruments and apparatus.

In order to overcome the above defects of the traditional electrochemical gas sensor, a plate-body thin-film type electrochemical gas sensor is creatively provided by the present disclosure, which has the advantages of simple production process, little environmental influence and is beneficial to matching the flattening of gas detection instruments and apparatus.

### SUMMARY

An electrochemical gas sensor is provided, consisting of a sensing electrode (1), a reference electrode (2), an auxiliary electrode (3), an electrolyte (4), a membrane material (5), and a sensor housing (6). The sensing electrode (1), the reference electrode (2) and the auxiliary electrode (3) are transversely arranged in the sensor housing (6). The sensor housing (6) above the sensing electrode (1) is provided with an air inlet (7). The sensing electrode (1), the reference electrode (2), the auxiliary electrode (3) and the membrane material (5) are immersed in the electrolyte (4). The sensor housing (6) is provided with a signal connector (8) nested in the bottom or side of the sensor.

The shapes of the sensing electrode (1), the reference electrode (2) and the auxiliary electrode (3) include, but are not limited to, a rectangle, a square, a circle, and a ring.

The shape of the signal connector (8) includes, but is not limited to, a circle or an L-shape. The signal connector (8) is nested in the bottom or side of the sensor, which greatly reduces the height of the sensor and makes the sensor more flattened.

The membrane material (5) includes, but is not limited to, glass fiber filter paper, a polypropylene membrane, a polyethylene membrane and a fluorine-containing vinyl membrane, and is immersed in the electrolyte (4) to play a role in maintaining electrolyte and increasing the wettability of the sensing electrode (1), the reference electrode (2) and the auxiliary electrode (3). The electrolyte (4) includes, but is not limited to, acid, base, salt and other solutions capable of releasing ions and or protons. The sensor housing (6) is provided with a liquid-filling hole for the injection of the electrolyte in the fabrication of the sensor, and then encapsulation is conducted after injection.

When a gas concentration is low (e.g., on the order of ppb or one billionth volume fraction concentration) or the sensitivity of the sensor is low, a separator (9) can be arranged at an outer ring of the sensing electrode (1), and a height of the separator is not less than a thickness of the sensing electrode (1), such that a separation chamber is formed, and gas molecules diffused in from the air inlet (7) cannot affect the reference electrode (2) and the auxiliary electrode (3). The membrane material (5) is arranged below the sensing electrode (1), the reference electrode (2) and the auxiliary electrode (3). The separator may be arranged on the sensor housing, or may be separated from the sensor housing.

It has been proved in the research process of the present disclosure that the plate-body thin-film type sensor is less affected by the change of ambient temperature, humidity and atmospheric pressure in comparison with complicated stress action inside the traditional cylindrical stacked sensor, and the problems of electrode breakage, poor contact and electrolyte leakage caused by the change of ambient temperature, humidity or atmospheric pressure in the design of the traditional cylindrical stacked sensor.

A fabrication method for an electrochemical gas sensor is further provided. The fabrication method includes, but is not limited to, the following steps:
providing an upper housing of the sensor, a lower housing of the sensor, a sensing electrode, a reference electrode, an auxiliary electrode, a membrane material, and an electrolyte;
fixing the three electrodes into the upper housing of the sensor;
fixing the membrane material into the lower housing of the sensor;
fixing and encapsulating the separately assembled upper and lower housings of the sensor by die pressing; and
injecting the electrolyte into a cavity filled with the membrane material from a small hole in the lower housing of the sensor.

In accordance with the fabrication method for the sensor, the upper housing of the sensor is provided with a vent, which is used for convection diffusion of a gas to be detected to the sensing electrode, thus generating a signal of the change of a current or a voltage between the sensing electrode and the reference electrode as well as the auxiliary electrode.

In accordance with the fabrication method for the sensor, the lower housing of the sensor is provided with a connector for connecting the three electrodes, which is connected to a signal amplification and processing circuit for gas detection and analysis.

In accordance with the fabrication method for the sensor, an electrode substrate can be firstly fixed to the upper housing of the sensor, and then slurry of the sensing electrode (1), the reference electrode (2) and the auxiliary electrode (3) is molded on the electrode substrate at one time by the technologies which include, but are not limited to, a 3D printing technology or a screen-printing technology. Alternatively, slurry of the sensing electrode (1), the reference electrode (2) and the auxiliary electrode (3) can be molded on an electrode substrate at one time by the technologies which include, but are not limited to, a 3D printing technology or a screen-printing technology, and the electrode substrate is then fixed to the upper housing of the sensor.

A plate-body electrochemical gas sensor and a fabrication method therefor created in accordance with the present disclosure can achieve the following beneficial effects:

1. The structure of the sensor is a plate body, and thus a structure design of the gas detection electronic instrument and apparatus is not limited by the height of the sensor, which is more flattened.

2. The structure of the sensor is a plate body and is simple, and thus the problems of the sensor such as electrode breakage, poor contact, electrolyte swelling and leakage and the like caused by the change of ambient temperature, humidity or pressure are solved.

3. The structure of the sensor is a plate body, which is simpler than the traditional cylindrical electrochemical gas sensor, simple in production process, and thus is beneficial to improving the production efficiency.

### BRIEF DESCRIPTION OF THE DRAWINGS

FIG. 1 is a schematic diagram I of a sectional structure of a sensor in accordance with the present disclosure;

FIG. 2 is a schematic diagram II of a sectional structure of a sensor in accordance with the present disclosure;

FIG. 3A is a structural schematic diagram of three electrodes of a sensor in accordance with a specific embodiment I of the present disclosure;

FIG. 3B is a structural schematic diagram of three electrodes of a sensor in accordance with a specific embodiment II of the present disclosure;

FIG. 3C is a structural schematic diagram of three electrodes of a sensor in accordance with a specific embodiment III of the present disclosure;

FIG. 3D is a structural schematic diagram of three electrodes of a sensor in accordance with a specific embodiment IV of the present disclosure;

FIG. 4A is a structural schematic diagram of a signal connector of a sensor in accordance with a specific embodiment I of the present disclosure;

FIG. 4B is a structural schematic diagram of a signal connector of a sensor in accordance with a specific embodiment II of the present disclosure;

FIG. 5 is a schematic diagram of a fabrication method for a sensor in accordance with the present disclosure.

### DETAILED DESCRIPTION OF THE EMBODIMENTS

The above description is only a preferred embodiment of the present disclosure and is not intended to limit the present disclosure. Any modification, equivalent replacement, improvement, etc. made within the spirit and principles of the present disclosure should be included within the scope of protection of the present disclosure.

### Specific Embodiment I

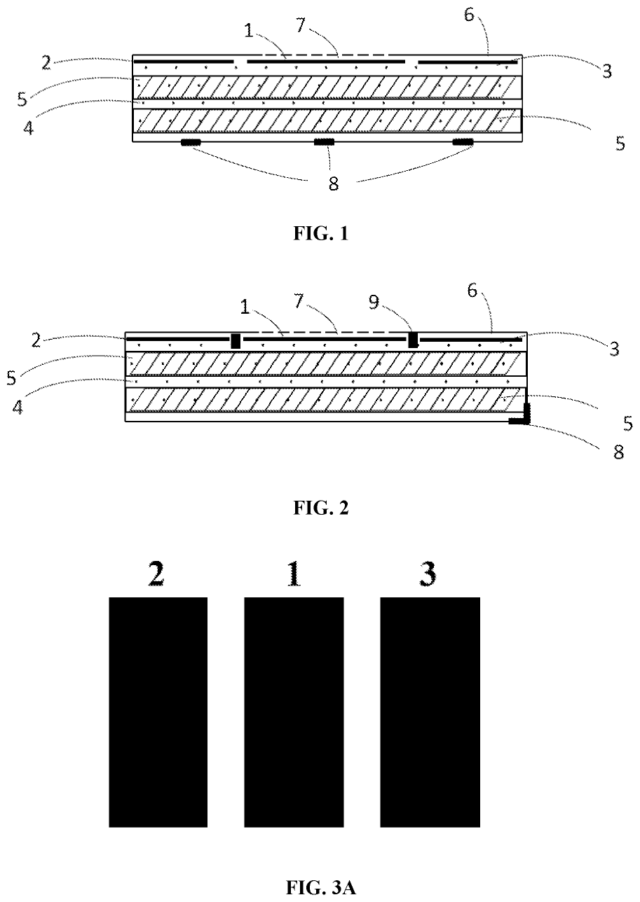

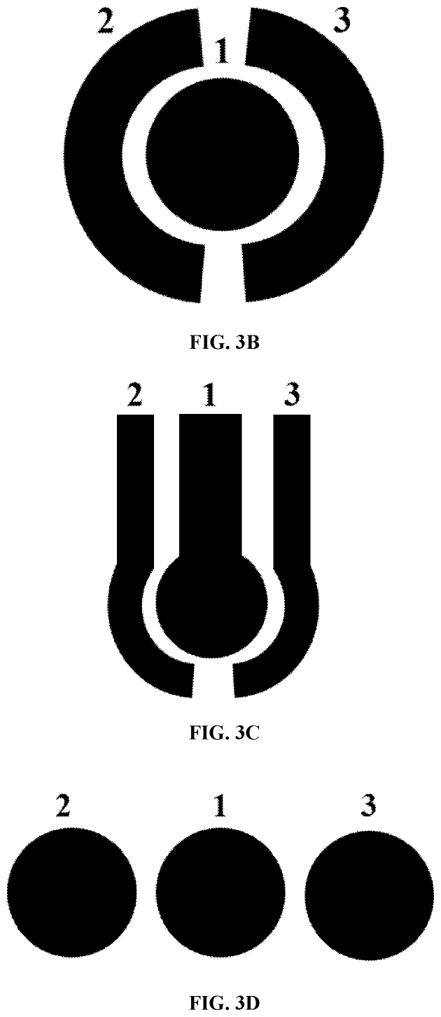

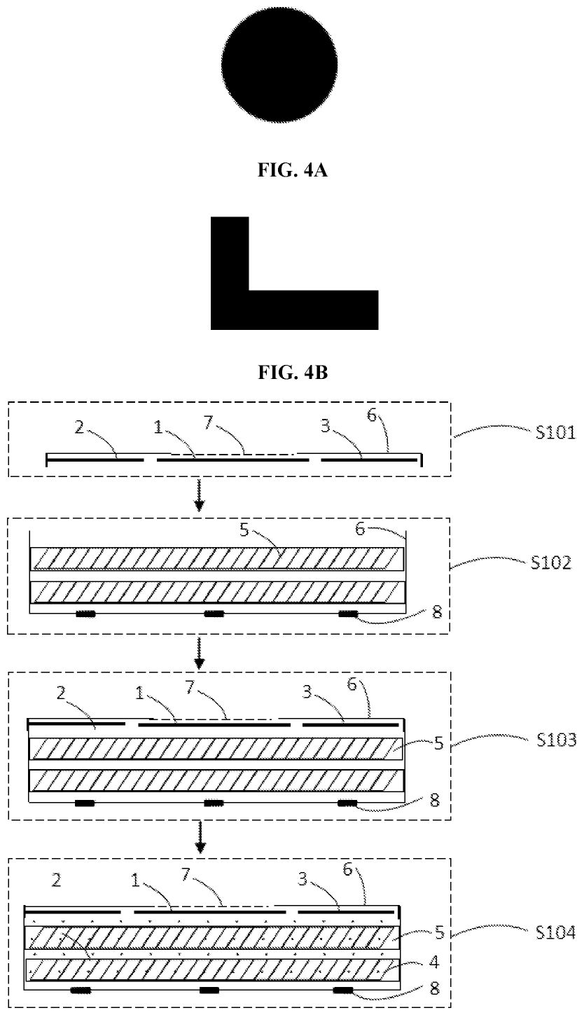

A structure (FIG. 1) of an electrochemical H2 sensor and a fabrication method (FIG. 5) therefor are described in this embodiment. A sensing electrode (1), a reference electrode (2) and an auxiliary electrode (3) of the sensor are in the shape of rectangle, as shown in FIG. 3A, and are transversely arranged in a sensor housing (6). The sensor housing (6) is provided with an air inlet (7). The sensing electrode (1), the reference electrode (2), the auxiliary electrode (3) and a membrane material (5) are immersed in an electrolyte (4). The sensor housing (6) is provided with a circular signal connector (8), as shown in FIG. 4A, and the circular signal connector (8) is nested in the bottom of the sensor.

The fabrication method is as shown in FIG. 5. In S101, electrode slurry is printed on a substrate at one time by a printing technology, and then the printed electrode is welded to an upper housing of the sensor by a fuse machine. In S102, the membrane material (5) is disposed on a lower housing of the sensor. In S103, the upper housing of the sensor and the lower housing of the sensor are welded by ultrasonic welding. In S104, the electrolyte (4) is injected from a small hole in the sensor housing and is encapsulated with glue.

### Specific Embodiment II

A structure (FIG. 2) of an electrochemical NO sensor and a fabrication method therefor (FIG. 5) are described in this embodiment. A sensing electrode (1) of the sensor is in the shape of circle, and a reference electrode (2) and an auxiliary electrode (3) of the sensor are in the shape of semi-ring, as shown in FIG. 3B, and the sensing electrode (1), the reference electrode (2) and the auxiliary electrode (3) are transversely arranged in a sensor housing (6). The sensing electrode (1) is located in the middle and is provided with a separator (9) at an outer ring. The separator is integrated with the upper housing of the sensor. The sensor housing (6) is provided with an air inlet (7). The sensing electrode (1), the reference electrode (2), the auxiliary electrode (3) and a membrane material (5) are immersed in an electrolyte (4). The sensor housing (6) is provided with an L-shaped signal connector (8), as shown in FIG. 4B, and the L-shaped signal connector (8) is nested in the bottom and side of the sensor.

The fabrication method is as shown in FIG. 5. In S101, an electrode substrate is welded to an upper housing of the sensor by a fuse machine, and then electrode slurry is printed on the substrate by a 3D printing technology. In S102, the membrane material (5) is disposed on the lower housing of the sensor. In S103, the upper housing of the sensor and the lower housing of the sensor are welded by ultrasonic welding. In S104, the electrolyte (4) is injected from a small hole in the sensor housing and then is encapsulated with glue.

### Specific Embodiment III

An electrochemical gas sensor is described in this embodiment, which consists of a sensing electrode (1), a reference electrode (2), an auxiliary electrode (3), an electrolyte (4), a membrane material (5) and a sensor housing (6). The sensing electrode (1), the reference electrode (2) and the auxiliary electrode (3) are transversely arranged in the sensor housing (6). The sensor housing (6) above the sensing electrode (1) is provided with an air inlet (7). The sensing electrode (1), the reference electrode (2), the auxiliary electrode (3) and the membrane material (5) are immersed in the electrolyte (4). The sensor housing (6) is provided with a signal connector (8) which is nested in the bottom or side of the sensor.

The shapes of the sensing electrode (1), the reference electrode (2), and the auxiliary electrode (3) are not limited to the shapes in the above embodiments. In Specific Embodiment III of the three electrode structures shown in FIG. 3C and Specific Embodiment IV of the three electrode structures shown in FIG. 3D, the shapes of the three electrodes may be the same or different, and may be any shape.

Compared with the traditional cylindrical electrochemical gas sensor, the sensor in the above embodiments is simple in structure and production process, which is beneficial to improving the production efficiency. When the electrochemical gas sensor provided by the present disclosure is applied to gas detection electronic apparatus and instruments, the apparatus structure is simple and more flattened.

The present disclosure is not limited to the embodiments shown and described, but any variations and modifications are within the scope of protection of the appended claims.

What is claimed is:

1. An electrochemical gas sensor, consisting of a sensing electrode (1), a reference electrode (2), an auxiliary electrode (3), an electrolyte (4), a membrane material (5) and a sensor housing (6), wherein the sensing electrode (1), the reference electrode (2) and the auxiliary electrode (3) are transversely arranged in the sensor housing (6); the sensor housing (6) above the sensing electrode (1) is provided with an air inlet (7); the sensing electrode (1), the reference electrode (2), the auxiliary electrode (3) and the membrane material (5) are immersed in the electrolyte (4); the sensor housing (6) is provided with a signal connector (8) which is nested in the bottom or side of the sensor.

2. The electrochemical gas sensor according to claim 1, wherein the shape of the sensing electrode (1), the reference electrode (2) and the auxiliary electrode (3) comprises, but is not limited to, a rectangle, a square, a circle, and a ring, and the shape of the signal connector (8) comprises, but is not limited to, a circle and an L-shape.

3. The electrochemical gas sensor according to claim 1, wherein the membrane material (5) comprises, but is not limited to, glass fiber filter paper, a polypropylene membrane, a polyethylene membrane, and a fluoroethylene membrane.

4. The electrochemical gas sensor according to claim 1, wherein the electrolyte (4) comprises, but is not limited to, acid, base, salt or other solutions capable of releasing ions or protons.

5. The electrochemical gas sensor according to claim 1, wherein a separator (9) is arranged on an outer ring of the sensing electrode (1), the height of the separator is not less than a thickness of the sensing electrode (1), thus forming a separation chamber.

6. A fabrication method for a sensor, comprising the following steps:
providing an upper housing of the sensor, a lower housing of the sensor, a sensing electrode, a reference electrode, an auxiliary electrode, a membrane material, and an electrolyte;
fixing the three electrodes into the upper housing of the sensor;
fixing the membrane material into the lower housing of the sensor;
fixing and encapsulating the separately assembled upper and lower housings of the sensor by die pressing; and
injecting the electrolyte into a cavity filled with the membrane material from a small hole in the lower housing of the sensor.

7. The fabrication method for a sensor according to claim 6, wherein the three electrodes are formed from electrode slurry configured on the upper housing of the sensor by means comprising, but not limited to, 3D printing or screen printing.

8. The fabrication method for a sensor according to claim 6, wherein the upper housing of the sensor is provided with a vent, which is used for convection diffusion of a gas to be detected to the sensing electrode, thus generating a signal of the change of a current or a voltage between the sensing electrode and the reference electrode as well as the auxiliary electrode.

9. The fabrication method for a sensor according to claim 6, wherein the lower housing of the sensor is provided with a connector for connecting the three electrodes, which is connected to a signal amplification and processing circuit for gas detection and analysis.
